(19) United States
(12) Patent Application Publication
(10) Pub. No.: US 2008/0077628 A1
(43) Pub. Date: Mar. 27, 2008

(54) CONFLICT RESOLUTION FOR DISTRIBUTED PROCESSING SYSTEMS

(75) Inventors: Robert N. Gonzalez, Boston, MA (US); Sean J. Martin, Webster, MA (US); Rouben Meschian, Boston, MA (US); Matthew N. Roy, Norwood, MA (US); Elias D. Torres, Lowell, MA (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/534,466

(22) Filed: Sep. 22, 2006

(51) Int. Cl. G06F 17/30

(52) U.S. Cl. 707/201

(57) ABSTRACT

Disclosed are a method, information processing system, and computer readable medium for managing data conflicts in a remote shared data store. The method includes receiving at least one modification request for a set of data elements stored in shared data storage. A unique identifier is generated for at least one of the modification request and a user interface element used to perform a modification associated with the modification request. A unique identifier associated with each data element to be modified is identified. A current state of the set of data elements is analyzed. A precondition value associated with the modification request is generated based on the current state of the set of data elements. The unique identifier of each data element is associated with the modification request. A transaction request associated with the modification request is sent to a server information processing system communicatively coupled to the shared data storage.

### FIELD OF THE INVENTION

The present invention generally relates to the field of distributed processing systems, and more particularly relates to conflict resolution for distributed processing systems.

### BACKGROUND OF THE INVENTION

In current distributed processing systems, clients can interact with distributed applications for creating and modifying data. The clients access a central or distributed data storage for modifying data as compared to working on a per-document basis. Therefore, a plurality of clients can be working on the same data simultaneously. This simultaneous interaction leads to conflicts within the data storage. For example, a client makes a local copy of the data it wants to modify. The client makes the desired changes to the local data, which is then sent to the data storage.

However, another client working on the same data merged its changes with the data storage prior to the first client. Therefore, the changes made by the first client were made to outdated data. In other words, a conflict now exists within the data store. The ability to detect and resolve these conflicts as they arise is necessary for any central/distributed data storage. However, in current distributed processing systems automatic resolution of these conflicts is generable not solvable, thereby forcing uses to manually perform merge operations. Having users manually surface and resolve conflicts is very inefficient and wastes valuable resources.

Therefore a need exists to overcome the problems with the prior art as discussed above.

### SUMMARY OF THE INVENTION

Briefly, in accordance with the present invention, disclosed are a method, information processing stream, and computer readable medium for managing data conflicts in a remote shared data store. The method includes receiving at least one modification request for a set of data elements stored in shared data storage. A unique identifier is generated for at least one of the modification request and a user interface element used to perform a modification associated with the modification request. A unique identifier associated with each data element in the set of data elements to be modified is identified. A current state of the set of data elements is analyzed. A precondition value associated with the modification request is generated based on the current state of the set of data elements. The unique identifier of each data element in the set of data elements is associated with the modification request. A transaction request associated with the modification request is sent to a server information processing system communicatively coupled to the shared data storage.

in another embodiment, a method on an information processing system communicatively coupled to a remote shared data storage for managing data conflicts in the storage is disclosed. The method comprises receiving at least one transaction request from a client information processing system. The transaction includes at least one modification request for modifying data in a shared data storage. A precondition value associated with the modification request is determined. A set of data elements to be modified by the modification request is also determined. A current state of the set of data elements within the shared data storage is determined. The current state of the set of data elements is compared against the precondition value. The method also includes determining, based on the comparing, if the precondition value matches the current state of the set of data elements. In response to the precondition value matching the current state, modifications to the set of data elements requested by the modification request are performed. In response to the precondition value failing to match the current state, the method determines that a conflict exists with the set of data elements in the shared data storage. The client system is notified of the conflict and denying the modification request.

In another embodiment an information processing system for managing data conflicts in the storage is disclosed. The information processing system includes a memory and a processor communicatively coupled to the memory. The information processing system also include a data modification module for receiving at least one modification request for a set of data elements stored in shared data storage. A unique identifier is generated for at least one of the modification request and a user interface element used to perform a modification associated with the modification request. A unique identifier associated with each data element in the set of data elements to be modified is identified. A current state of the set of data elements is analyzed. A precondition value associated with the modification request is generated based on the current state of the set of data elements. The unique identifier of each data element in the set of data elements is associated with the modification request. A transaction request associated with the modification request is sent to a server information processing system communicatively coupled to the shared data storage.

In yet another embodiment, a computer readable medium for managing data conflicts in a remote shared data store is disclosed. The computer readable medium includes instructions for receiving at least one modification request for a set of data elements stored in shared data storage. A unique identifier is generated for at least one of the modification request and a user interface element used to perform a modification associated with the modification request. A unique identifier associated with each data element in the set of data elements to be modified is identified. A current state of the set of data elements is analyzed. A precondition value associated with the modification request is generated based on the current state of the set of data elements. The unique identifier of each data element in the set of data elements is associated with the modification request. A transaction request associated with the modification request is sent to a server information processing system communicatively coupled to the shared data storage.

One advantage of the present invention is that it provides automatic conflict resolution for shared data. Modification requests are generated when a user modifies shared data on a local machine. Preconditions are also generated that are associated with the modification requests to detect and surface conflicts when the modifications are attempted at the local store. If a conflict is detected, a user is visually shown where in a document the conflict exists and, in one embodiment, is also shown the conflicting data. This allows the user to either cancel his/her modification request of the change the modification request based on the conflicting data.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a distributed processing system according to an embodiment of the present invention;

FIG. 2 illustrates an exemplary graphical user interface for resolving conflicts in the a distributed processing system according to an embodiment of the present invention;

FIG. 3 is a block diagram illustrating an exemplary system architecture for a distributed processing system according to an embodiment of the present invention;

FIG. 4 is a more detailed view of the processing nodes of FIG. 3 according to the present invention;

FIG. 5 is an operational flow diagram illustrating an exemplary process of sending a modification request to a shared data store according to an embodiment of the present invention;

FIG. 6 is an operational flow diagram illustrating an exemplary process of detecting a data conflict in a shared data store according to an embodiment of the present invention; and

FIG. 7 is an operational flow diagram illustrating an exemplary process of resolving data conflicts in a shared data store according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Exemplary Massively Parallel Processing System

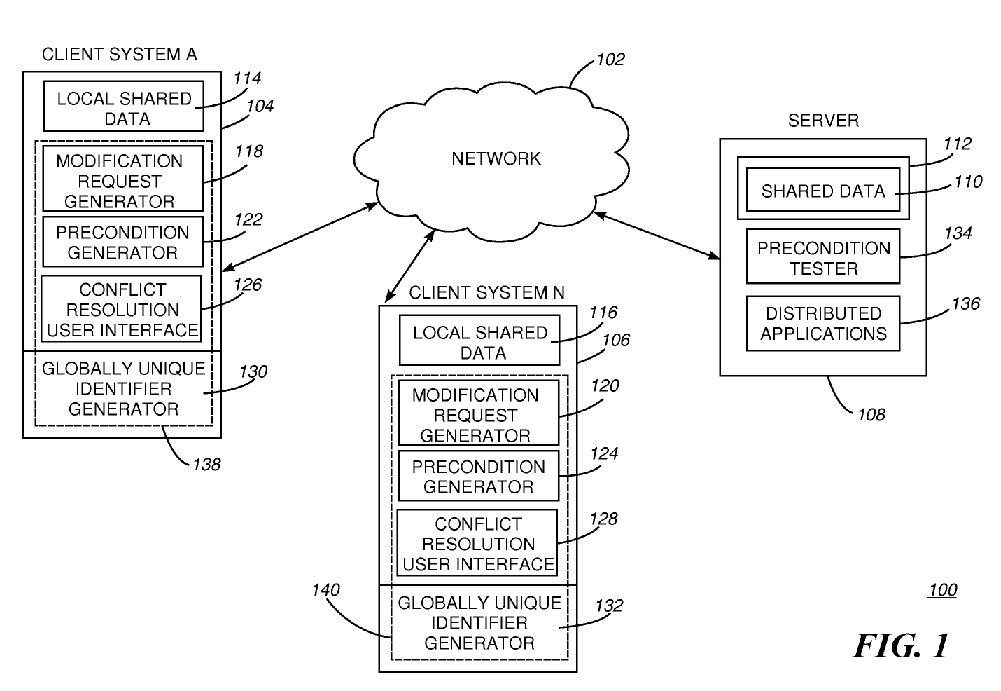

According to an embodiment of the present invention, as shown in FIG. 1, an exemplary distributed processing system 100 is illustrated. FIG. 1 shows a network 102 that connects a plurality of information processing systems such as client system A 104 and client system N 106 to a server 108. The network 102 supports any number of information processing systems 104, 106, 108. The client systems 104, 106 and the server 108, in one embodiment, are personal computers, workstations, personal digital assistants, or the like. The network 102 can be a wide area network such as the Internet, a local area network, or the like.

Each of the client systems 104, 106 are communicatively coupled to each other and the server 108 via the network 102. In the current example, the client systems 104, 106, server 108, and the network 102 are part of the distributed processing system 100. In one embodiment, the client systems 104, 106 access data stored on the server 108. A copy of the data to be accessed is stored locally on the client system 104, 106. From hereon in the data accessed by each of the client systems 104, 106 is referred to as “shared data” 110. The shared data 110, in the current example, resides within a shared data store 112 such as a relational database, extensible markup language (“XML”) documents, resource description framework (“RDF”) graphs, or the like.

A shared data store 112, in one embodiment, allows a plurality of clients to access the same data. The shared data 110 does not have to reside on the server 108. For example, the shared data 110 can reside within a distributed data store comprising a plurality of remote information processing systems. The shared data 110 can also reside within a central data store located on the server 108 or on a remote information processing system communicatively coupled to the server 108. In the examples where the shared data resides on one or more remote information processing systems, the client systems 104, 106 access the data through the server 108.

The client systems 104, 106 can interact with the shared data 100 via distributed applications 136 residing on the server 108. For example, each client system 104, 106 initializes a distributed application 136 such as a spreadsheet application for creating, and modifying the shared data 110. The client systems 104, 106 modify the data locally (i.e. the local shared data 114, 116), which is then merged with the shared data 110 on the shared data store 112. Therefore, local changes to the data 114, 116 are not reflected in the shared data store 112 until the data 114, 116 is sent back to the shared data store 112. However, in the distributed processing system 100 other clients may also be interacting with the same data or data that affects the data 114, 116. Therefore, when one client system 104, 106 tries to modify certain data, those modifications may conflict with modifications made by another client system 104, 106.

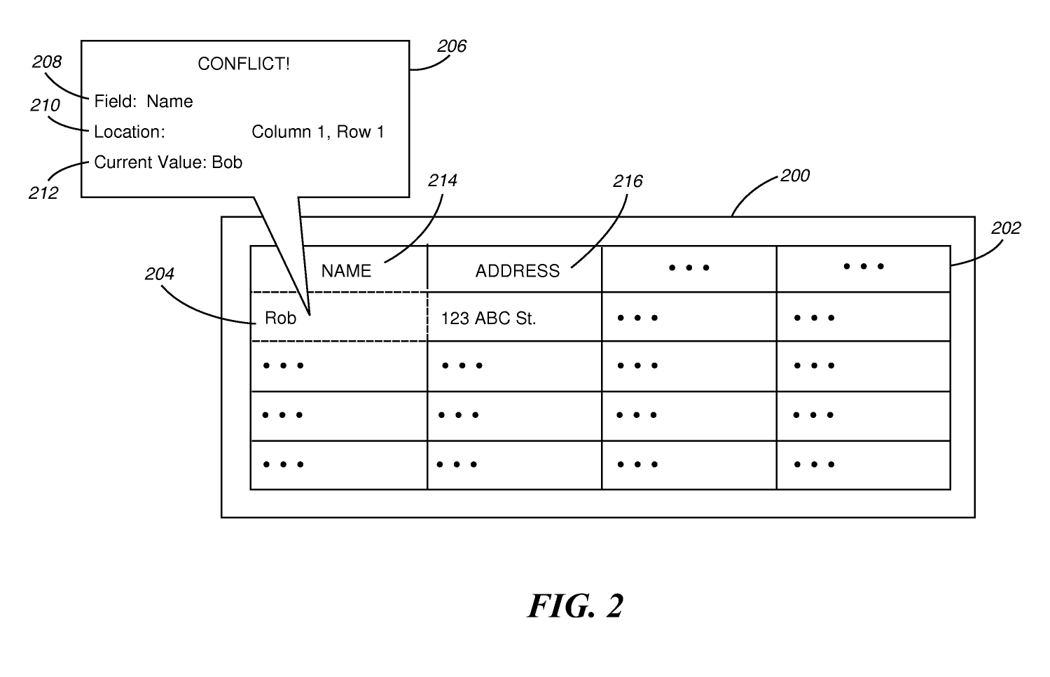

To resolve these conflicts, a command or modification request generator 118, 120, a precondition generator 122, 124, a conflict resolution user interface 126, 128, and a globally unique identifier generator 130, 132 are provided to the client systems 104, 106. In one embodiment, these components reside within a data modification module 138, 140. For example, the distributed application 136 being used by a client system 104, 106 provides each of these modules 118, 122, 126, 130 to a client system 104, 106. These modules can reside locally on a client system 104, 106, as shown in FIG. 1 or can alternatively reside on the information processing system including the distributed application 136 such as the server 108. As a user interacts with the local shared data 114, 116 through, for example, a form provided by the distributed application 136, a command or modification request is generated by the modification request generator 118 for one or more modifications to the local shared data 114. A modification request, in one embodiment, encapsulates the change in state of the value or values presented by a field or set of fields. For example, if the distributed application presents form 200 (FIG. 2) to a user including various fields such as a “Name” field (214), an “Address field” (216), and the like, a modification request can be generated for each change to each field value. Alternatively, a single modification request can be generated that includes all of the modifications requested by the user.

In the embodiment where the distributed application 136 presents a form to the user for interacting the local shared data 114, 116, each element of the form such as the form itself, the fields of the form, sub-forms, and the like are assigned a globally unique identifier. The globally unique identifier is generated, in this example, by the globally unique identifier generator 130, 132. When a user modifies the local shared data 114, 116, a modification request is generated that encapsulates the modification and the globally unique identifier generator 126 generates a unique identifier for the modification request. A globally unique identifier can be created for the modification(s) itself, the data to be modified, the application used to make the modification, the form, document, or sheet the modification was performed in, and the like. By associating a globally unique identifier with all of these elements, the location of a conflict can be identified and displayed to a user through the conflict resolution user interface 126, 128.

When a modification request is generated, the precondition generator 122 performs a precondition query against the local shared data 114, 116. Alternatively, the precondition query can also be performed against the shared data 110 in the shared store 112. The precondition query can be a query such as an SQL query, SPARQL query, XPath query, or the like. The precondition query creates an “expected result” based on the modification request and the local shared data 114, 116 (or the shared data 110 in the shared store 112). This “expected result” becomes a precondition that is associated with the modification request. For example, consider an example of a form having a “Name” filed. The local shared data 114, 116 shows the current value in the name field being “Rob” and a user wants to change the field from “Rob” to “Robert”. The precondition generator 122 performs a query on the local shared data 114, 116. The precondition generator 122 generates the precondition that for the modification request to be valid, the “Name” field must be “Rob” prior to performing the modification. If the “Name” field is not “Rob”, for example, because another user has modified the data, then the modification is not performed at the shared data store 112.

A transaction is created that includes all the modification requests, the unique identifiers associated with each modification request, the unique identifiers for the application used to perform the modification, the unique identifiers for the sheets, forms, or documents where the modification was performed on, and the preconditions associated with each modification request. In one embodiment, the modification requests are stored in a transaction in a first-in-first-out fashion. The transaction is sent to the server 108 which analyzes the transaction. Each modification request tests its precondition against the shared data 110 in the shared store 112. For example, a precondition tester 134 analyzes the shared data 110 to determine if the current state of the shared data 110 matches the precondition associated with the modification request. Using the example above, for a modification request to change a field value from “Rob” to “Robert”, the precondition tester 134 checks to see whether the field to be changed is currently “Rob”. It be noted that the precondition tester 134 can also reside within a client system 104, 106.

If the precondition of a modification request passes, the requested modification is allowed and the client system is notified of a successful modification request. If, however, the precondition fails, the client system 104, 106 is notified of the failure. In other words, a conflict exists within the shared data 110. For example, another user has changed the value for the field comprising “Rob”. In one embodiment, the client system 104, 106 notifies the user of the failure. The notification can be a visual and/or an audible notification. For example, a conflict resolution user interface 126 visually indicates to the user the conflict on the form including the conflict. The conflict resolution user interface 126 can highlight an area on the form where the conflict exists, highlight the conflicting data, change the color of the text associated with the data, display a message, or the like. The unique identifiers associated with each modification, data set, application, forms, sheets, or documents, enables the conflict resolution user interface 126 to display the conflict to the user. The present invention creates a mapping from the change made by a user to the shared store which can be displayed back to a user for conflict resolution.

As can be seen, the present invention provides automatic conflict resolution for shared data. Modification requests are generated when a user modifies shared data on a local machine. Preconditions are also generated that are associated with the modification requests to detect and surface conflicts when the modifications are attempted at the local store. If a conflict is detected, a user is visually shown where in a document the conflict exists and, in one embodiment, is also shown the conflicting data. This allows the user to either cancel his/her modification request of the change the modification request based on the conflicting data.

It should be noted that the example above of only changing a single field value and a precondition only testing a single element is for illustrative purposes. The modification request and the precondition can be arbitrarily complex. For example, a plurality of fields in a plurality of forms can be modified in a single modification request. A precondition can also test for a plurality of conditions.

Exemplary User Conflict Resolution Interface

FIG. 2 is a block diagram illustrating an exemplary conflict resolution user interface 200. In one embodiment, the conflict resolution user interface 200 is provided by the distributed application being used by a user of a client system 104, 106 to interact with the shared data 110 residing in the shared data store 112. When a conflict is detected (e.g., when a precondition fails) the conflict resolution user interface 200, in one embodiment, displays the form 202 or forms including the conflicting data to the user.

The conflict resolution user interface 200, in one embodiment, visually indicates to the user the field comprising the data conflict. In the example of FIG. 2, the “Name” entry 204 including the value “Rob” is highlighted as indicated by the dashed lines. The form 202, in this embodiment, is the same form used by the user prior to the user's modification request. In other words, because a conflict exists with the user's request of changing “Rob” to “Robert”, the form shows the value prior to the modification, which was “Rob”. However, in another embodiment, the form 202 can display the conflicting data. For example, instead of showing “Rob”, which is what the user knew the value to be prior to his/her modification request, the entry display what the value currently is, for example “Bob”.

The conflict resolution user interface 200, in one embodiment, can also display a message 206 notifying the user of a conflict. For example, the message 206 shown in FIG. 2 includes the field identifier 208 “Name”, the location 210 “Column 1, Row 1”, and what the conflicting data 212 “Bob”, i.e., the current actual value, is. The message 206 allows for the user to easily identify the conflicting data and its location. The conflict resolution user interface 200 allows the user to cancel the modification request, for example, the user can select to cancel his/her changes because the changes made by another user may be what the current user desired. The conflict resolution user interface 200 also allows a user to change the modification request. For example, after reviewing the conflict, a user can decide to re-submit the modification request or modify the request based on the conflict.

In the example of FIG. 2, the user can decide to change “Bob” to “Robert”. Therefore, a modification request is generated for this modification and a precondition is generated for this modification. However, the precondition is now set to test that the “Name” field associated with the modification be “Bob”, as compared to “Rob” with the previous modification request.

Distributed Processing System Architecture

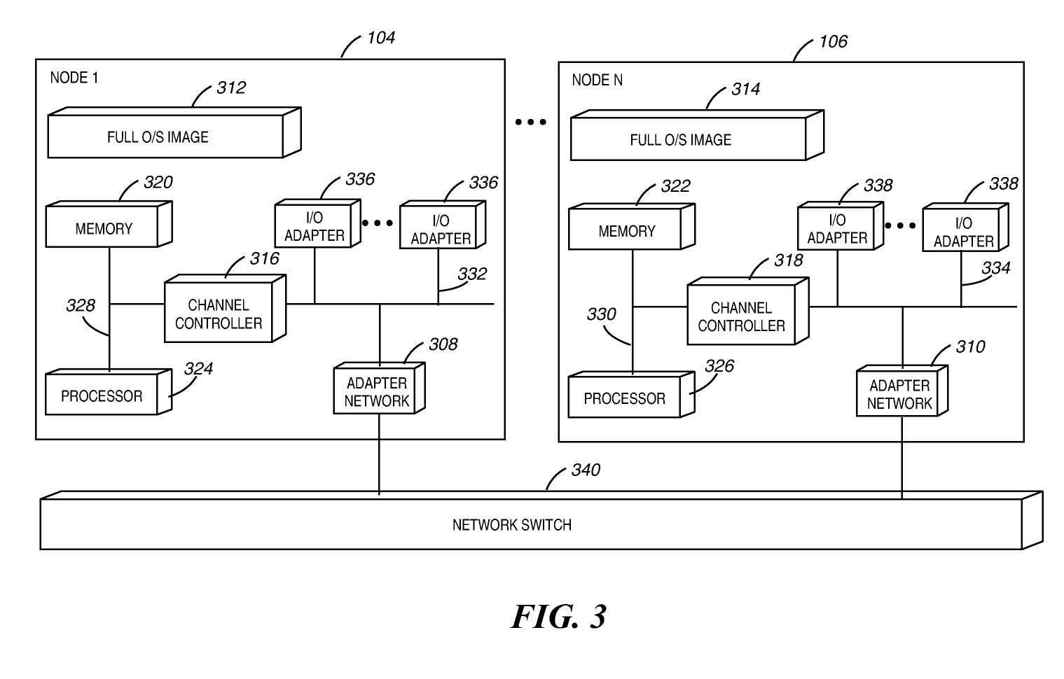

FIG. 3 is a block diagram illustrating an exemplary architecture for the distributed processing system 100 of FIG. 1. In one embodiment, the distributed processing system 100 can operate in an SMP computing environment. The distributed processing system 100 executes on a plurality of processing nodes 104, 106 coupled to one another node via a plurality of network adapters 308, 310. Each processing node 104, 106 is an independent computer with its own operating system image 312, 314, channel controller 316, 318, memory 320, 322, and processor(s) 324, 326 on a system memory bus 328, 330. A system input/output bus 332, 334 couples I/O adapters 336, 338 and network adapter 308, 310. Although only one processor 324, 326 is shown in each processing node 104, 106, each processing node 104, 106 is capable of having more than one processor. Each network adapter is linked together via a network switch 340. In some embodiments, the various processing nodes 702, 104 are able to be part of a processing cluster. All of these variations are considered a part of the claimed invention. It should be noted that the present invention is also applicable to a single information processing system.

Information Processing System

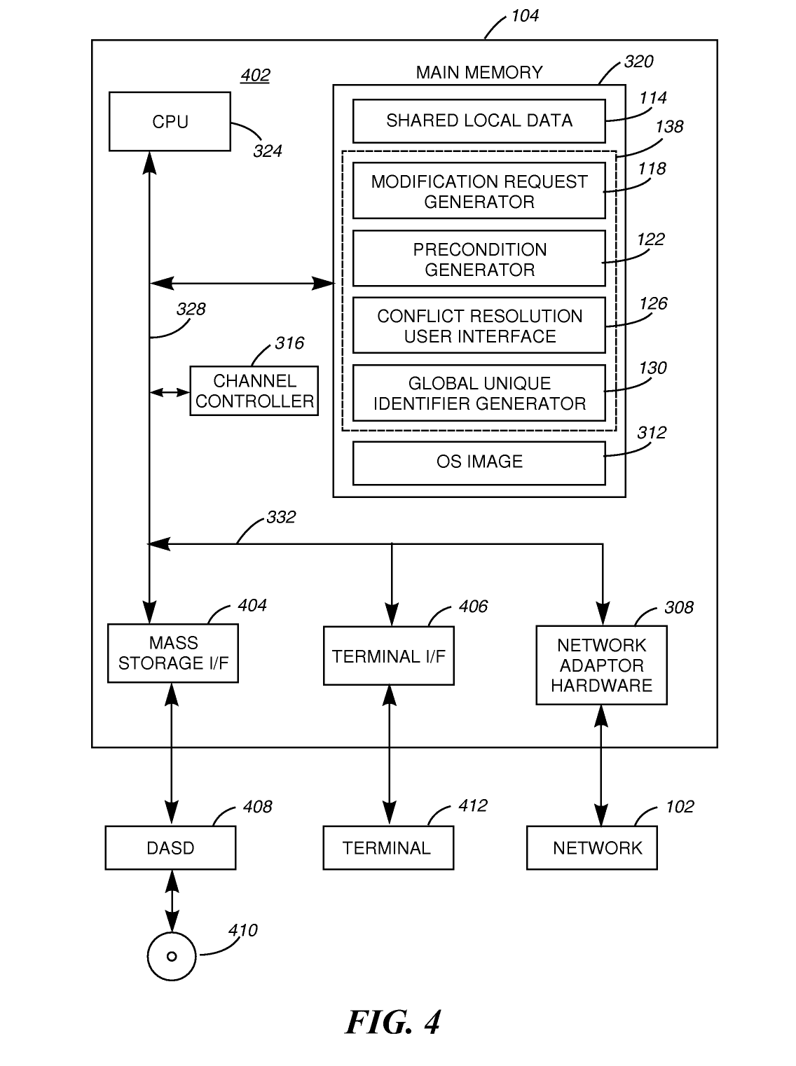

FIG. 4 is a block diagram illustrating a more detailed view of the processing node 104 of FIG. 1, which from hereon in is referred to as information processing system 104. The information processing system 104 is based upon a suitably configured processing system adapted to implement the exemplary embodiment of the present invention. Any suitably configured processing system is similarly able to be used as the information processing system 104 by embodiments of the present invention, for example, a personal computer, workstation, or the like. The information processing system 104 includes a computer 402. The computer 402 includes a processor 324, main memory 320, and a channel controller 316 on a system bus 328. A system input/output bus 332 couples a mass storage interface 404, a terminal interface 406 and network hardware 308. The mass storage interface 404 is used to connect mass storage devices such as data storage device 408 to the information processing system 104. One specific type of data storage device is a computer readable medium such as a CD drive or DVD drive, which may be used to store data to and read data from a CD 410 (or DVD). Another type of data storage device is a data storage device configured to support, for example, NTFS type file system operations.

The main memory 320, in one embodiment, includes the shared local data 114, modification request generator 118, precondition generator 122, conflict resolution user interface 126 and globally unique identifier generator 130. A discussed above, the local shared data 114 is a copy of shared data residing in a shared data store 110. A user of the information processing system 104 can interact with this local shared data 114 via a distributed application. The modification request generator 118, precondition generator 122, conflict resolution user interface 126 and globally unique identifier generator 130 reside within the data modification module 138 and can all be provided to the information processing system via the distributed application.

Although only one CPU 324 is illustrated for computer 402, computer systems with multiple CPUs can be used equally effectively. Embodiments of the present invention further incorporate interfaces that each includes separate, fully programmed microprocessors that are used to off-load processing from the CPU 324. The terminal interface 406 is used to directly connect the information processing system 104 with one or more terminals 412 to the information processing system 104 for providing a user interface to the computer 402. These terminals 412, which are able to be non-intelligent or fully programmable workstations, are used to allow system administrators and users to communicate with the information processing system 104. A terminal 412 is also able to consist of user interface and peripheral devices that are connected to computer 802.

An operating system image 312 included in the main memory 320 is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 104. The network adapter hardware 106 is used to provide an interface to the network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via a CD/DVD, e.g. CD 410, or other form of recordable media, or via any type of electronic transmission mechanism.

Exemplary Process for Sending a Modification Request to a Shared Data Store

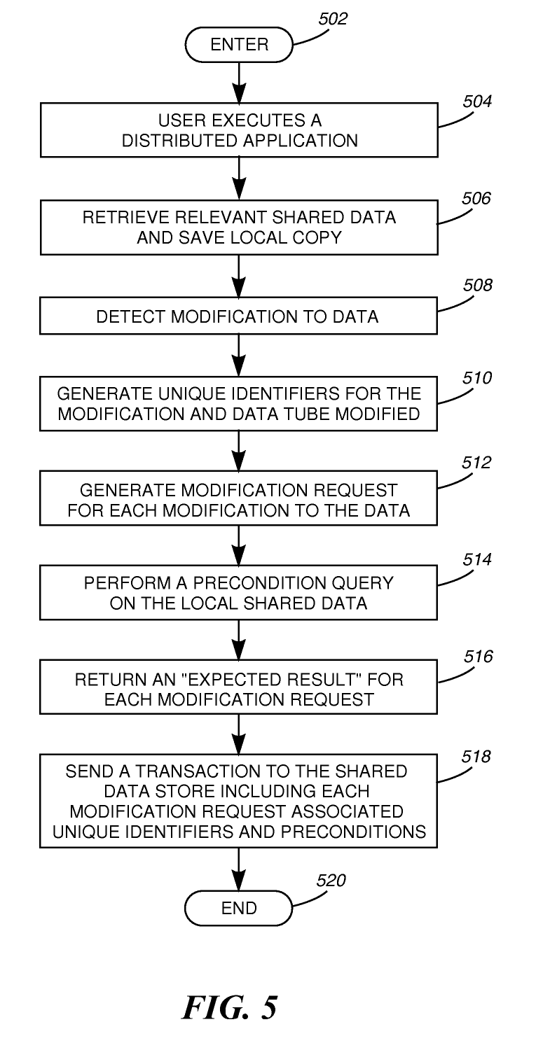

FIG. 5 illustrates an exemplary process for sending a modification request to a shared data store 112. The operational flow diagram of FIG. 5 begins at step 502 and flows directly to step 504. A user, at step 504, executes a distributed application. The distributed application allows for a user to interact with shared data 110 in a shared data store 112. The distributed application, at step 506, retrieves the relevant shared data 110 from the shared data store 112 and creates a local copy 114. The user changes the local shared data 114 and this change(s), at step 508, is detected. Unique identifiers, at step 510, are generated for any modifications to the local shared data 114 and the local shared data 114 to be modified.

A modification request, at step 512, is generated for the changes made by the user to the local shared data 114. Precondition queries, at step 514, are performed on the local shared data 114, 116 within the client system 104, 104. Alternatively, precondition queries can also be performed on the related shared data 110 at the shared data store 112. An “expected result”, at step 516, is returned from each precondition query and associated with each respective modification request. As discussed above, the “expected result” encapsulates the state of the shared data 110 in the shared data store 12 that is required for the modification request to be valid. A transaction, at step 518, which includes each modification request and their associated unique identifiers and preconditions. This transaction is then sent to the shared data store 112. The control flow then exits at step 520.

Exemplary Process for Detecting a Data Conflict in a Shared Data Store

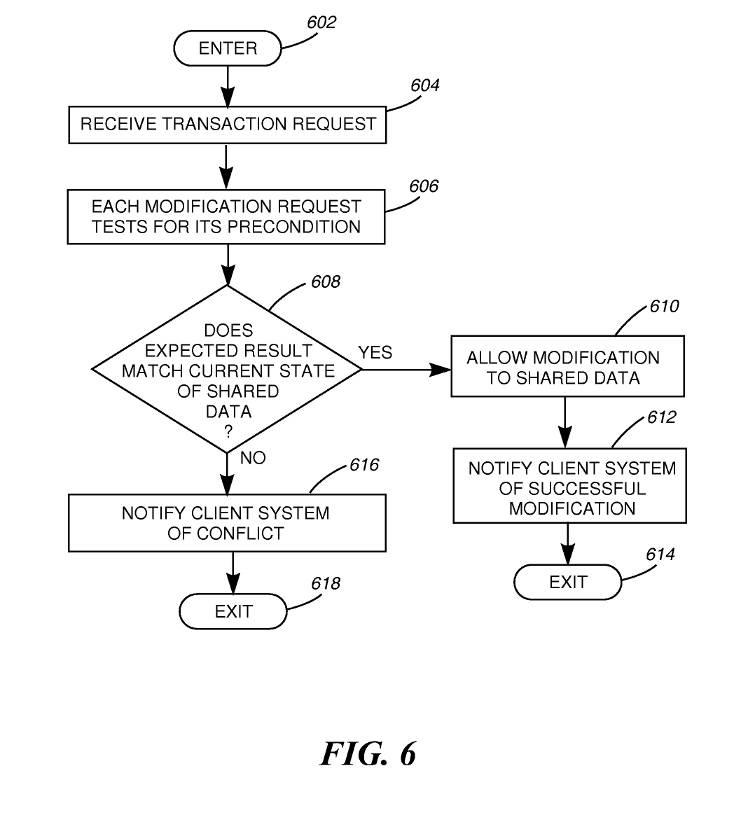

FIG. 6 illustrates an exemplary process for detecting a data conflict in a shared data store 112. The operational flow diagram of FIG. 6 begins at step 602 and flows directly to step 604. The shared data store 112, at step 604, receives a transaction request from a client system 104, 106. Each modification request within the transaction, at step 606, tests for its precondition. The modification request, at step 608, determines if the “expected result” of its precondition matches the current state of the shared data 110. If the result of this determination is positive, the modification to the shared data 110 is allowed. The client system 104, 106, at step 612, is notified of a successful modification. The control flow then exits at step 614. If the result of this determination is negative, the client system 104, 106 is notified of a data conflict. For example, once a data conflict is detected, the conflict can be displayed to the user through the conflict resolution user interface 126, 128. The globally unique identifiers associated with the modifications, applications, sheets, forms, or documents allow the conflict resolution user interface 126 to display the conflicting data to the user. The control flow then exits at step 618.

Exemplary Process for Resolving Data Conflicts in a Shared Data Store

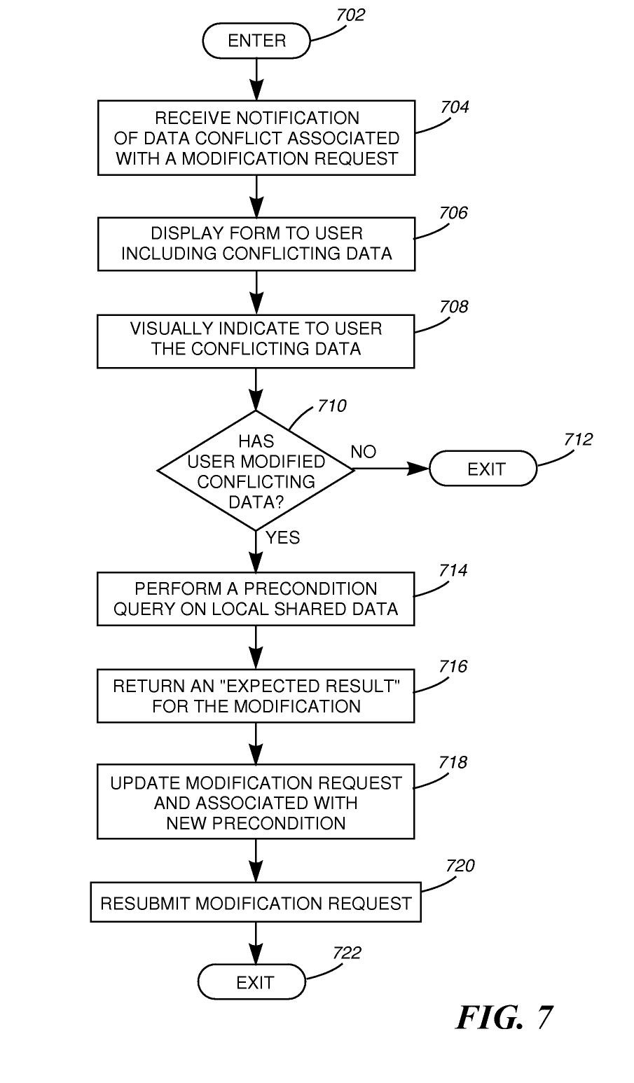

FIG. 7 illustrates an exemplary process for resolving data conflicts in the shared data store 112. The operational flow diagram of FIG. 7 begins at step 702 and flows directly to step 704. The client system 104, 106, at step 704, receives a notification that a data conflict associated with a modification request exists. The distributed application, at step 706, through the conflict resolution user interface 126 displays a form 200 to the user including the conflicting data. The conflict resolution user interface 126, at step 708, visually indicates to the user the conflicting data. For example, the field comprising the conflicting data can be highlights, shaded, include different colored text, a message 206 can be displayed, or the like, as discussed above.

The distributed application, at step 710, determines if the user has modified the conflicting data. If the result of this determination is negative, the control flow exits at step 712. If the result of this determination is positive, a precondition query, at step 714, is performed on the local shared data 114, 116 (or the related shared data 110 at the shared data store 112). An “expected result”, at step 716, is returned for the modification. The modification request, at step 718, is updated to include the new precondition. The updated modification request is then submitted to the shared data store. The process discussed above with respect to FIG. 6 is then performed for the updated modification request. The control flow then exits at step 722.

Non-Limiting Examples

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing data conflicts in a remote shared data store, the method on a client information processing system comprising:
receiving at least one modification request for a set of data elements stored in shared data storage;
generating a unique identifier for at least one of the modification request and a user interface element used to perform a modification associated with the modification request;
identifying a unique identifier associated with each data element in the set of data elements to be modified;
analyzing a current state of the set of data elements;
generating a precondition value associated with the modification request based on the current state of the set of data elements;
associating the unique identifier of each data element in the set of data elements with the modification request; and
sending a transaction request associated with the modification request to a server information processing system communicatively coupled to the shared data storage.

2. The method of claim 1, wherein the transaction request includes the modification request, the unique identifier of the modification request, the unique identifier of each data element in the set of data elements, the precondition value for the modification request, and the unique identifier of the user interface element.

3. The method of claim 1, further comprising:
displaying at least the set of data elements to a user through a graphical user interface.

4. The method of claim 1, further comprising:
receiving a notification from the server information processing system that data associated with the modification request conflicts with related data in the shared data storage;
visually indicating to a user through the graphical user interface that a conflict with the modification request exists.

5. The method of claim 4, wherein the visually indicating further comprises at least one of:
displaying a message to the user;
displaying and highlighting the set of data elements associated with the modification request;
visually changing text associated with the set of data elements; and
displaying conflicting data in the shared data storage associated with the modification request.

6. The method of claim 4, further comprising:
receiving at least one updated modification request for the set of data elements based on conflicting data in the shared data storage;
generating a unique identifier for the updated modification request;
analyzing a new current state of the set of data elements, wherein the set of data elements now includes the conflicting data;
generating a new precondition value associated with the updated modification request based on the new current state of the set of data elements;
sending a new transaction request associated with the updated modification request to the server information processing system, wherein the new transaction request includes at least the updated modification request, the unique identifier of the updated modification request, and the new precondition value for the updated modification request.

7. The method of claim 1, wherein the precondition value is at least based on at least one data element outside of the set of data elements.

8. The method of claim 1, wherein the shared data storage is one of:
a relational database,
a XML database, and
a RDF graph database.

9. The method of claim 1, wherein the generating the precondition value further comprises:
executing a precondition query against local shared data associated with data in the shared data storage.

10. The method of claim 8, wherein the precondition query is one of:
a. SQL query,
a SPARQL query, and
a Xpath query.

11. The method of claim 1, wherein the transaction is a serializable order set of modification request instances.

12. A method for a method for managing data conflicts in a remote shared data storage, the method on an server information processing system communicatively coupled to the remote shared data storage comprising:
receiving at least one transaction request from a client information processing system, wherein the transaction includes at least one modification request for modifying data in a shared data storage;
determining a precondition value associated with the modification request;
determining a set of data elements to be modified by the modification request;
determining a current state of the set of data elements within the shared data storage;
comparing the current state of the set of data elements against the precondition value;
determining, based on the comparing, if the precondition value matches the current state of the set of data elements;
performing, in response to the precondition value matching the current state, modifications to the set of data elements requested by the modification request;
determining, in response to the precondition value failing to match the current state, that a conflict exists with the set of data elements in the shared data storage; and
notifying the client system of the conflict and denying the modification request.

13. An information processing system for managing data conflicts in a remote shared data store, the information processing system comprising:
a memory;
a processor communicatively coupled to the memory;
a data modification module communicatively coupled to the memory and the processor, wherein the data modification module is for:
receiving at least one modification request for a set of data elements stored in shared data storage;
generating a unique identifier for at least one of the modification request and a user interface element used to perform a modification associated with the modification request;
identifying a unique identifier associated with each data element in the set of data elements to be modified;
analyzing a current state of the set of data elements;
generating a precondition value associated with the modification request based on the current state of the set of data elements;
associating the unique identifier of each data element in the set of data elements with the modification request; and
sending a transaction request associated with the modification request to a server information processing system communicatively coupled to the shared data storage.

14. The information processing system of claim 13, wherein the data modification module is further for:
displaying at least the set of data elements to a user through a graphical user interface.

15. The information processing system of claim 13, wherein the data modification module is further for:
receiving a notification from the server information processing system that data associated with the modification request conflicts with related data in the shared data storage;
visually indicating to a user through the graphical user interface that a conflict with the modification request exists, wherein the visually indicating further comprises at least one of:
displaying a message to the user;
displaying and highlighting the set of data elements associated with the modification request:
visually changing text associated with the set of data elements; and
displaying conflicting data in the shared data storage associated with the modification request.

16. The information processing system of claim 15, wherein the data modification module is further for:
receiving at least one updated modification request for the set of data elements based on conflicting data in the shared data storage;
generating a unique identifier for the updated modification request;
analyzing a new current state of the set of data elements, wherein the set of data elements now includes the conflicting data;
generating a new precondition value associated with the updated modification request based on the new current state of the set of data elements;
sending a new transaction request associated with the updated modification request to the server information processing system, wherein the new transaction request includes at least the updated modification request, the unique identifier of the updated modification request, and the new precondition value for the updated modification request.

17. A computer readable medium for managing data conflicts in a remote shared data store, the computer readable medium comprising instructions for:
receiving at least one modification request for a set of data elements stored in shared data storage;
generating a unique identifier for at least one of the modification request and a user interface element used to perform a modification associated with the modification request;
identifying a unique identifier associated with each data element in the set of data elements to be modified;
analyzing a current state of the set of data elements;
generating a precondition value associated with the modification request based on the current state of the set of data elements;
associating the unique identifier of each data element in the set of data elements with the modification request; and
sending a transaction request associated with the modification request to a server information processing system communicatively coupled to the shared data storage.

18. The computer readable medium of claim 17, wherein the data modification module is further for:
displaying at least the set of data elements to a user through a graphical user interface.

19. The computer readable medium of claim 17, wherein the data modification module is further for:
receiving a notification from the server information processing system that data associated with the modification request conflicts with related data in the shared data storage;
visually indicating to a user through the graphical user interface that a conflict with the modification request exists, wherein the visually indicating further comprises at least one of:
displaying a message to the user;
displaying and highlighting the set of data elements associated with the modification request;
visually changing text associated with the set of data elements; and
displaying conflicting data in the shared data storage associated with the modification request.

20. The computer readable medium of claim 17, wherein the data modification module is further for;
receiving at least one updated modification request for the set of data elements based on conflicting data in the shared data storage;
generating a unique identifier for the updated modification request;
analyzing a new current state of the set of data elements, wherein the set of data elements now includes the conflicting data;
generating a new precondition value associated with the updated modification request based on the new current state of the set of data elements;
sending a new transaction request associated with the updated modification request to the server information processing system, wherein the new transaction request includes at least the updated modification request, the unique identifier of the updated modification request, and the new precondition value for the updated modification request.
